(19) United States
(12) Patent Application Publication
(10) Pub. No.: US 2017/0277373 A1
(43) Pub. Date: Sep. 28, 2017

(54) MULTI-DIMENSIONAL REMOTE CONTROL DEVICE AND OPERATION CONTROLLING METHOD THEREOF

(71) Applicant: SAMSUNG ELECTRONICS CO., LTD., Suwon-si (KR)

(72) Inventors: Seong-wook JEONG, Seoul (KR); Sin-wi MOON, Seoul (KR); Kyung-jin KIM, Seoul (KR); Min-hyung KIM, Seoul (KR); Ga-min PARK, Seoul (KR); Hyo-seung PARK, Seoul (KR); So-yon YOU, Seoul (KR); Kwan-min LEE, Seoul (KR); Sang-joon LEE, Dangjin-si (KR); Jun-woo LEE, Seoul (KR); Kyung-hwa JUNG, Anyang-si (KR)

(21) Appl. No.: 15/471,434

(22) Filed: Mar. 28, 2017

(30) Foreign Application Priority Data
Mar. 28, 2016 (KR) 10-2016-0036960

(51) Int. Cl. G06F 3/0482; G06F 3/0481; G08C 17/02; G06F 3/01; H05B 37/02; G06F 3/0488; G06F 3/16

(52) U.S. Cl. CPC G06F 3/0482; G06F 3/0488; G06F 3/04817; G06F 3/167; G06F 3/017; H05B 37/0227; G08C 17/02; G08C 2201/32

(57) ABSTRACT

A multi-dimensional remote control device which may be more effectively manipulated and a method of controlling an operation thereof are provided. The remote control device for controlling an electronic device may include a processor configured to activate an input interface provided on one surface from among input interfaces provided on at least one of multiple surfaces of the remote control device, to receive an input from the activated input interface, and to transmit the input to the electronic device via a communication interface.

### CROSS-REFERENCE TO RELATED APPLICATION

This application is based on and claims priority under 35 U.S.C. §119 to Korean Patent Application No. 10-2016-0036960, filed on Mar. 28, 2016, in the Korean Intellectual Property Office, the disclosure of which is incorporated by reference herein in its entirety.

### BACKGROUND

1. Field

The present disclosure relates generally to remote control devices, and for example, to a multi-dimensional remote control device and a method of controlling an operation thereof.

2. Description of Related Art

As electronic devices have become smarter, the number of functions to be performed in such electronic devices has increased. Thus, the number of buttons to be included in a remote control device which remotely controls an electronic device has been necessarily increased.

Buttons are arranged on a front surface of an existing remote control device to control functions of an electronic device. Thus, as the number of functions of an electronic device increases, the size of a remote control device is getting larger. When the size of the remote control device is large, the remote control device can be difficult to manipulate with one hand.

Accordingly, there is a need to develop a remote control device which may be more effectively manipulated.

### SUMMARY

A remote control device which may be effectively manipulated using multiple surfaces thereof and a method of controlling an operation thereof are provided.

Additional aspects will be set forth in part in the description which follows and, in part, will be apparent from the description.

According to an example aspect of an example embodiment, there is a multi-dimensional remote control device including user input interfaces. The remote control device controlling an electronic device includes an input interface comprising input circuitry provided on at least one of multiple surfaces of the remote control device, and configured to receive an input; a grip portion; a communication interface comprising communication circuitry configured to establish communication with the electronic device; and a processor configured to activate an input interface provided on one of the multiple surfaces, to receive an input from the activated input interface, and to transmit the input to the electronic device via the communication interface.

The remote control device may further include a sensor configured to detect at least one of a direction of rotation and an angle of rotation of the remote control device. The processor may detect a surface facing upward among the multiple surfaces on the basis of a sensing value output from the sensor, and activate a user input interface provided on the detected surface.

The remote control device may further include a light detection sensor installed on the grip portion and configured to sense light in the vicinity of the grip portion. The processor may activate an input interface provided on one of the multiple surfaces based on a sensing value output from the light detection sensor.

The remote control device may further include a sensor configured to sense whether the remote control device is in a standing state; and a voice recognition interface configured to recognize a voice signal. When it is determined based on a sensing value output from the sensor that the remote control device is in the standing state, the processor may activate the voice recognition interface, receive a voice signal via the voice recognition interface, and transmit the voice signal to the electronic device via the communication interface.

The remote control device may further include a light detection sensor installed on the grip portion and configured to sense light in the vicinity of the remote control device. After the voice recognition interface is activated, the processor may deactivate the voice recognition interface when it is determined based on a sensing value output from the light detection sensor that the light in the vicinity of the remote control device is equal to or greater than a predetermined value.

The remote control device may further include a light configured to emit light to the outside of the remote control device. When the voice recognition interface is activated, the processor may control the light to emit light indicating an activated state of the voice recognition interface.

The remote control device may further include a light mounted on some regions of the multiple surfaces. The processor may control the light to emit light indicating a surface corresponding to the activated user input interface.

The input interface may include a touch screen. The processor may cancel a screen save mode and set an input reception mode for a touch screen mounted on an activated surface of the multiple surfaces, and set the screen save mode and an input reception blocking mode for a touch screen mounted on a deactivated surface of the multiple surfaces.

According to an example aspect of another example embodiment, there is provided a method of controlling an operation of a multi-dimensional remote control device including input interfaces. The method of controlling an electronic device includes activating an input interface provided on one of multiple surfaces of the remote control device; receiving an input from the activated input interface; and transmitting the input to the electronic device.

The activating of the input interface provided on one of the multiple surfaces of the remote control device may include detecting at least one of a direction of rotation and an angle of rotation of the remote control device; detecting a surface facing upward among the multiple surfaces based on the detected at least one of the direction of rotation and the angle of rotation; and activating an input interface provided on the detected surface.

The activating of the input interface provided on one of the multiple surfaces of the remote control device may include sensing light in the vicinity of a grip portion of the remote control device; and activating an input interface provided on one of the multiple surfaces on the basis of a value of the sensed light.

The method may further include sensing whether the remote control device is in a standing state; and activating a voice recognition function of the remote control device when it is sensed that the remote control device is in the standing state.

The method may further include sensing light in the vicinity of the remote control device after the voice recognition function of the remote control device is activated; and deactivating the voice recognition function when it is determined that the light in the vicinity of the remote control device has a value equal to or less than a predetermined value.

The method may further include emitting light indicating an activated state of the voice recognition function to the outside of the remote control device when the voice recognition function is activated.

When the input interface provided on the surface of the multiple surfaces is activated, the method may further include emitting light indicating the surface corresponding to the activated input interface to the outside.

When input interfaces provided on the multiple surfaces are touch screens, the activating of the input interface provided on the surface among the multiple surfaces may include canceling a screen save mode and setting an input reception mode for a touch screen mounted on an activated surface among the multiple surfaces; and setting the screen save mode and an input reception blocking mode for a touch screen mounted on a deactivated surface among the multiple surfaces.

According to an example aspect of another example embodiment, a non-transitory computer-readable recording medium having recorded thereon a program for performing the method described above in a computer is provided.

### BRIEF DESCRIPTION OF THE DRAWINGS

These and/or other aspects, features and attendant advantages of the present disclosure will become apparent and more readily appreciated from the following detailed description, taken in conjunction with the accompanying drawings, in which like reference numerals refer to like elements, and wherein:

FIG. 1 is a diagram illustrating an example remote control device and an electronic device controlled by the remote control device, according to an example embodiment;

FIGS. 2A, 2B, 2C and 2D are diagrams illustrating examples of an appearance of a remote control device according to example embodiments;

FIG. 3 is a block diagram illustrating an example remote control device according to an example embodiment;

FIG. 4 is a diagram illustrating an example of a table showing information regarding functions of buttons included in first to fourth input interfaces of a remote control device according to example embodiments;

FIGS. 5 and 6 are block diagrams illustrating example remote control devices according to example embodiments;

FIGS. 7A, 7B, 7C and 7D are diagrams illustrating examples of an appearance of a remote control device according to example embodiments;

FIG. 8 is a block diagram illustrating an example remote control device according to another example embodiment;

FIGS. 9A, 9B, 9C and 9D are diagrams illustrating examples of an appearance of a remote control device according to example embodiments;

FIGS. 10, 11, and 12 are flowcharts illustrating example methods of controlling an operation of a remote control device according to example embodiments; and

FIG. 13 is a diagram illustrating example control of a plurality of devices using a remote control device according to an example embodiment.

### DETAILED DESCRIPTION

Various example of the present disclosure will be described in greater detail with reference to the accompanying drawings below so that those of ordinary skill in the art can easily implement the present disclosure. However, the present disclosure may be embodied in many different forms and is not limited to embodiments set forth herein. For clarity, parts that are not related to clearly describing the present disclosure are omitted in the drawings. Throughout the present disclosure, like elements are assigned like reference numerals.

In the present disclosure, it will be understood that when an element is referred to as being ‘connected to’ another element, the element can be directly connected to another element or can be electrically connected to another element having an element therebetween. On the other hand, it will be understood that when an element is referred to as ‘including’ another element, the element may further include other elements and the presence of other elements is not excluded. As used herein, the term ‘and/or’ includes any and all combinations of one or more of the associated listed items. Expressions such as ‘at least one of,’ when preceding a list of elements, modify the entire list of elements and do not modify the individual elements of the list.

Hereinafter, the present disclosure will be described in detail with reference to the accompanying drawings.

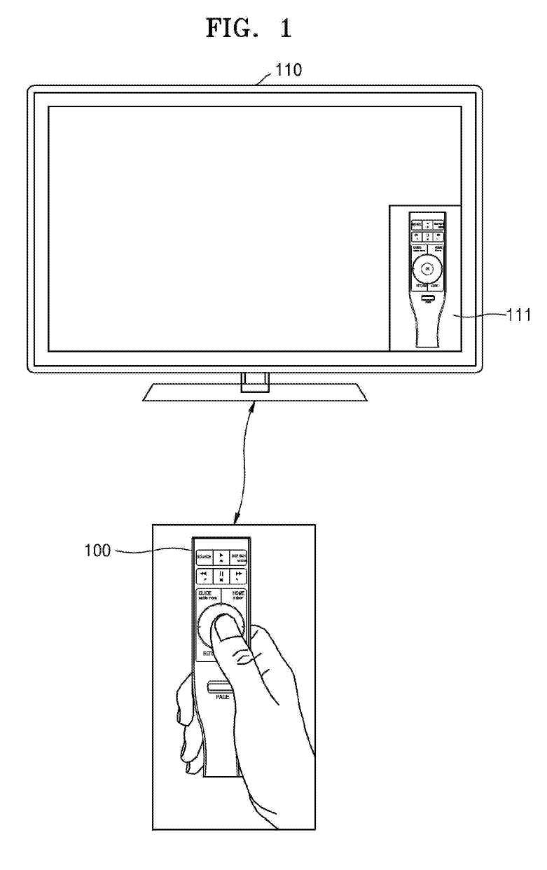

FIG. 1 is a diagram illustrating an example remote control device 100 and an electronic device 110 controlled by the remote control device 100, according to an example embodiment.

The remote control device 100 of FIG. 1 may, for example, have a polyhedron structure. The polyhedron structure may include a hexahedron structure but is not limited to the hexahedron structure in the present disclosure. Thus, in some embodiments of the present disclosure, the remote control device 100 may be configured as having a three-dimensional (3D) structure or a 3D shape. Different function buttons may be arranged on multiple surfaces of the remote control device 100. The remote control device 100 having the arrangement of the function buttons may be referred to as a multi-dimensional remote control device 100 or multi-surface remote control device 100.

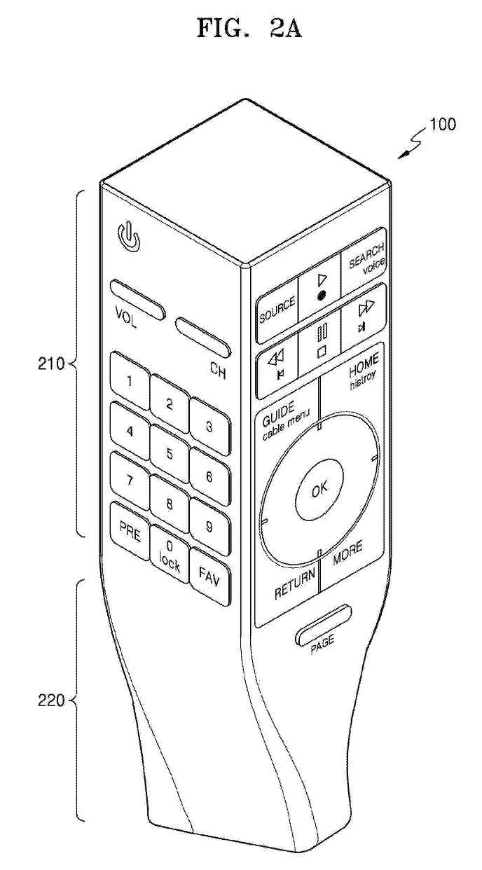

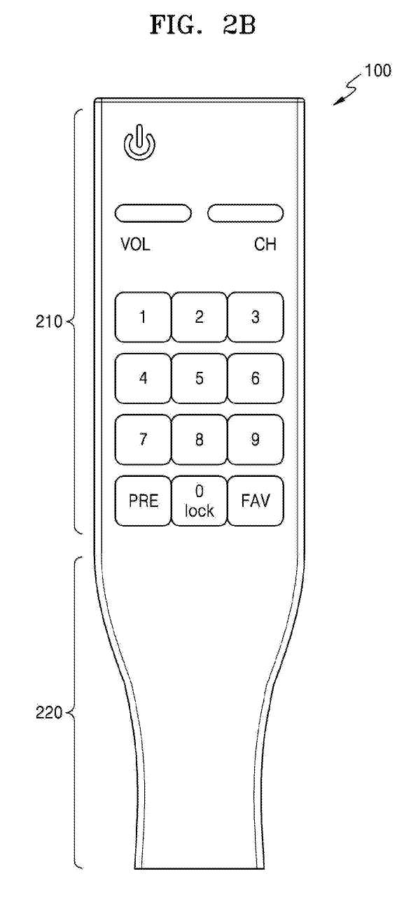

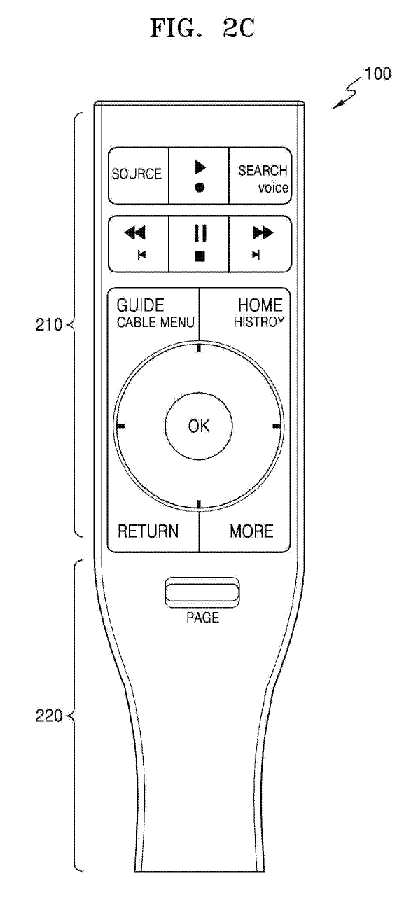

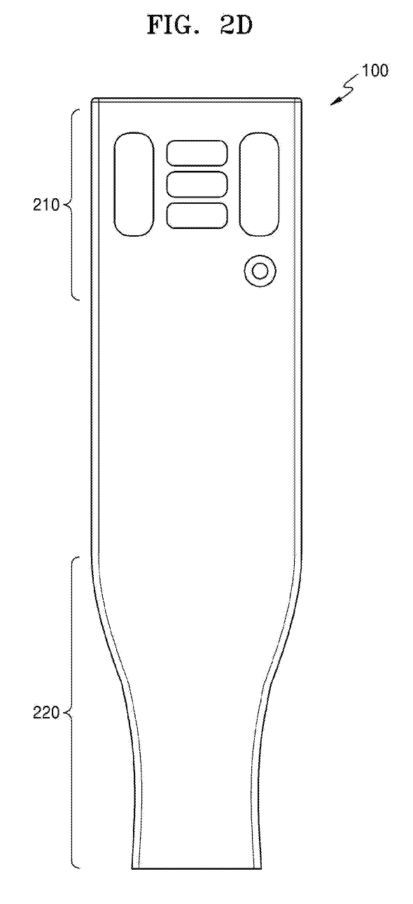

FIGS. 2A, 2B, 2C and 2D are diagrams illustrating examples of an appearance of a remote control device 100 according to various example embodiments.

FIG. 2A is a diagram illustrating the appearance of the remote control device 100, viewed from an angle at which two surfaces of the remote control device 100 may be seen. The two surfaces of the remote control device 100 illustrated in FIG. 2A may be a front surface and a right side surface thereof. Referring to FIG. 2A, the remote control device 100 may include an input interface 210 and a grip portion 220 provided on each of the surfaces thereof.

The input interface 210 may include at least one key button. One of functions of the input interface 210 may be mapped to one of the surfaces of the remote control device 100. When one of the functions of the input interface 210 is mapped to one of the surfaces of the remote control device 100, the input interface 210 may include one key button or may not include any key button.

The grip portion 220 is a portion of the remote control device 100 which a user may grip. No function button is provided on the grip portion 220. Since no function button is provided on the grip portion 220, a user need not worry about inadvertently pressing an undesired button when gripping the remote control device 100. Furthermore, a number of times a location on a palm where the remote control device 100 is gripped is changed to manipulate the remote control device 100 may be decreased.

FIG. 2B is a diagram illustrating the appearance of the remote control device 100, viewed from an angle at which one surface of the remote control device 100 may be shown. FIG. 2B is a front view of the remote control device 100.

FIG. 2C is a diagram illustrating the appearance of the remote control device 100, viewed from an angle at which another surface of the remote control device 100 may be shown. FIG. 2C is a right side view of the remote control device 100.

FIG. 2D is a diagram illustrating the appearance of the remote control device 100, viewed from an angle at which another surface of the remote control device 100 may be shown. FIG. 2D is a left side view of the remote control device 100.

No function button may be provided on a rear surface of the remote control device 100 but the present disclosure is not limited thereto. A function button to be provided on the rear surface of the remote control device 100 may include a button that a user can set the function. The button that the user can set the function may include, for example, a ‘run now’ button, but is not limited thereto. The ‘run now’ button may be set on the basis of a function which the user has frequently used. For example, the ‘run now’ button may be set to a function of directly moving to a channel, an application, or a source designated by a user irrespective of whether the electronic device 100 is powered on or off. A function corresponding to the ‘run now’ button may be changed according to a user input.

Referring to FIGS. 2A to 2D, the remote control device 100 includes the input interface 210 on at least one from among multiple surfaces of the remote control device 100 and the grip portion 220. The grip portion 220 may have surfaces having naturally curved corner portions. By configuring the grip portion 220 as described above, a user may easily manipulate the remote control device 100 while gripping the remote control device 100 with one hand and can minimize the movement of the user's finger for manipulating the remote control device 100. In the present disclosure, the structure of the grip portion 220 is not limited to that described above.

A portion of each of the multiple surfaces of the remote control device 100 on which the input interface 210 is located may be formed of an opaque material, and the grip portion 220 may be formed of a transparent material. The portion of each of the multiple surfaces of the remote control device 100 on which the input interface 210 is located, and the grip portion 220 may be formed of the same material but have different degrees of transparency as described above. Alternatively, the portion of each of the multiple surfaces of the remote control device 100 on which the user input interface 210 is located, and the grip portion 220 may have the same degree of transparency.

Referring to FIG. 1, the electronic device 110 may be controlled by the remote control device 100. The electronic device 110 may include a smart household appliance (e.g., a smart television (TV)), an Internet of Things (IoT)-based device, or a content reproducer but is not limited thereto in the present disclosure.

Referring to FIG. 1, the electronic device 110 may display a notice image 111 providing a notification of an activated surface from among the multiple surfaces of the remote control device 100. Through the notice image 111, the user may be easily made aware of the currently activated surface of the remote control device 100.

The notice image 111 may include an image containing a button which is the same as that of the currently activated surface of the remote control device 100. When a button of the remote control device 100 is controlled, the notice image 111 may display the controlled button to be differentiated from the other non-controlled buttons. Thus, the notice image 111 may be updated whenever a button of the remote control device 100 is controlled. The notice image 111 may be updated whenever an activated surface of the remote control device 100 is switched to another activated surface. The notice image 111 may include a notice image reflecting a change in a state of the remote control device 100 in real time.

Referring to FIG. 1, the electronic device 110 displays the notice image 111 at a lower left or right corner but a location of the notice image 111 displayed is not limited to that illustrated in FIG. 1 in the present disclosure.

The electronic device 110 may continuously display the notice image 111 but the present disclosure is not limited thereto. For example, the notice image 111 may be displayed for a certain time and then disappear whenever the activated surface of the remote control device 100 are switched to the other active surface or whenever a function button of the remote control device 100 is controlled.

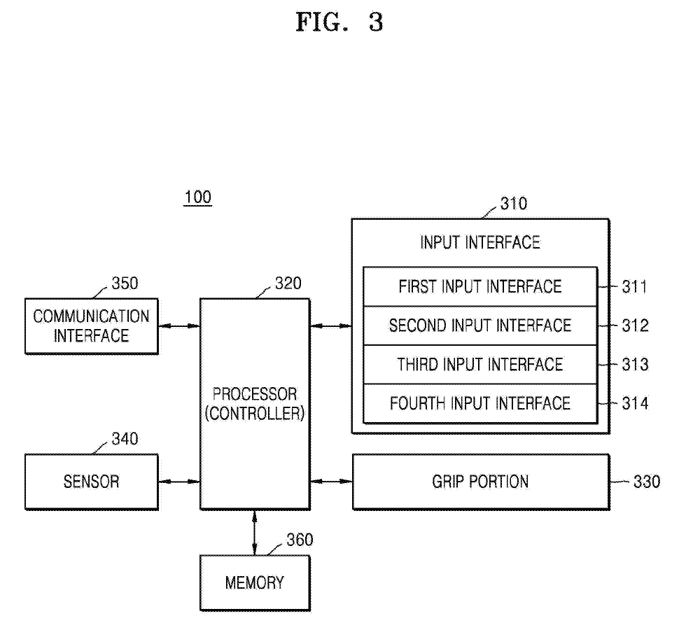

FIG. 3 is a block diagram illustrating an example remote control device 100 according to an example embodiment. Referring to FIG. 3, the remote control device 100 includes an input interface 310, a processor (e.g., including processing circuitry) 320, a grip portion 330, a sensor 340, a communication interface (e.g., including communication circuitry) 350, and a memory 360.

The input interface 310 may include first to fourth input interfaces 311, 312, 313, and 314 corresponding to multiple surfaces of the remote control device 100. The first input interface 311, the second input interface 312, the third input interface 313, and the fourth input interface 314 may be respectively provided on a front surface, a right side surface, a left side surface, and a rear surface of the remote control device 100 but are not limited thereto in the present disclosure.

When the input interface 310 is provided only on the front surface and the right and left side surfaces of the remote control device 100, the input interface 310 may be changed to include only the first to third input interfaces 311, 312, and 313.

The processor 320 may include various processing circuitry and may be referred to as a controller controlling overall functions of the remote control device 100. The processor 320 may activate one of the first to fourth input interfaces 311, 312, 313, and 314 based on a sensing value output from the sensor 340. If the first input interface 311 is activated, the processor 320 may transmit an input received from the first input interface 311 to the electronic device 110 via the communication interface 350. The processor 320 may block or ignore inputs received from deactivated input interfaces from among the first to fourth input interfaces 311 to 314.

The sensor 340 may include a sensor capable of sensing at least one of a direction of rotation and an angle of rotation of the remote control device 100. For example, the sensor 340 may include a 6-axis gyroscope sensor.

When a sensing value output from the sensor 340 represents that the front surface of the remote control device 100 faces upward, the processor 320 may activate the first input interface 311. The activating of the first input interface 311 may be understood as activating an input receiving/controlling function corresponding to a key button included in the first input interface 311. When one function is mapped to the first input interface 311 and the first input interface 311 is activated according to the sensing value output from the sensor 340, the remote control device 100 may automatically execute the function mapped to the first input interface 311.

When the sensing value output from the sensor 340 represents that the right side surface of the remote control device 100 faces upward, the processor 320 may activate the second input interface 312. When one function is mapped to the first input interface 311, one function may be mapped to each of the second to fourth input interfaces 312 to 314 but a plurality of functions may be mapped to each of the second to fourth input interfaces 312 to 314.

When the sensing value output from the sensor 340 represents that the left side surface of the remote control device 100 faces upward, the processor 320 may activate the third input interface 313. When the sensing value output from the sensor 340 represents that the rear surface of the remote control device 100 faces upward, the processor 320 may activate the fourth input interface 314.

The processor 320 may consider a certain error range of a sensing value output from the sensor 340. For example, when a sensing value output from the sensor 340 represents that the right side surface of the remote control device 100 is moved more upwardly than the front surface thereof while the remote control device 100 is rotated to turn the front surface downward and turn the right side surface upward, the processor 320 may switch an activated state of the first input interface 311 provided on the front surface to an activated state of the second input interface 312 provided on the right side surface.

Thus, content to be provided from the electronic device 110 may be changed. For example, if the first input interface 311 is related to live broadcasting, the second input interface 312 is related to a home menu of the electronic device 110, and the electronic device 110 provides content based on a live channel, the electronic device 110 which is providing a live TV broadcast may be changed to provide a home menu screen when the remote control device 100 is rotated to activate the second input interface 312. As described above, a may easily change operating modes of the electronic device 110 by simply rotating the remote control device 100.

The sensor 340 may further include a light detection sensor provided on the grip portion 330. When the sensor 340 includes the light detection sensor, the processor 320 may detect the area of a user's hand gripping the grip portion 330 based on a sensing value output from the sensor 340. The processor 320 may activate one of the first to fourth input interfaces 311 to 314 on the basis of the detected area of the user's hand. For example, the processor 320 may detect, as a surface facing upward, a surface of the grip portion 330 on which an area in which light is sensed is wide, and activate an input interface provided on the detected surface.

Thus, one of the first to fourth input interfaces 311 to 314 which does not face upward may be activated. For example, if an area of a user's hand which is in contact with the surface on which the fourth input interface 314 is located among surfaces of the grip portion 300 which are gripped is wider than that of the user's hand which is in contact with surfaces of the first to third input interfaces 311 to 313 which are gripped, the processor 320 may activate the first input interface 311 even when the first input interface 311 faces downward.

The grip portion 330 may be integrally formed with the input interface 310 as described above with reference to FIGS. 2A to 2D.

The communication interface 350 may include various communication circuitry and change an input received from the input interface 310 into a form which may be received by the electronic device 110, and transmit the changed input to the electronic device 110. For example, when communication established between the remote control device 100 and the electronic device 110 is based on infrared ray (IR) communication, the communication interface 350 may change the input to be transmitted on the basis of the IR communication and transmit the changed input.

The communication interface 350 may be configured to establish data communication between the remote control device 100 and the electronic device 110 so as to set a function of a button for which a function may be set by a user among the buttons included in the first to fourth input interfaces 311 to 314.

The communication interface 350 may include various communication circuitry, such as, for example, but is not limited to, a near-field communication module to establish a near-field communication such as radio-frequency (RF) communication, Bluetooth communication, or WiFi communication.

The memory 360 may store a program and/or data for activating one of the first to fourth input interfaces 311 to 314 by the remote control device 100 under control of the processor 320. For example, the memory 360 may store information regarding mapping between the first to fourth input interfaces 311 to 314 and sensing values to be output from the sensor 340.

The memory 360 may include an internal memory and/or an external memory. The memory 360 may include a volatile memory such as a dynamic random access memory (DRAM), a static RAM (SRAM), or a synchronous DRAM (SDRAM); a nonvolatile memory such as a one-time programmable read-only memory (OTPROM), a programmable ROM (PROM), an erasable PROM (EPROM), an electrically EPROM (EEPROM), a mask ROM, a flash ROM, a NAND flash memory, or a NOR flash memory; a flash drive such as a solid-state drive (SSD), a compact flash (CF) card, a secure digital (SD) card, a micro-SD card, a mini-SD card, an Xd card, or a memory stick; or a storage device such as a hard disc drive (HDD).

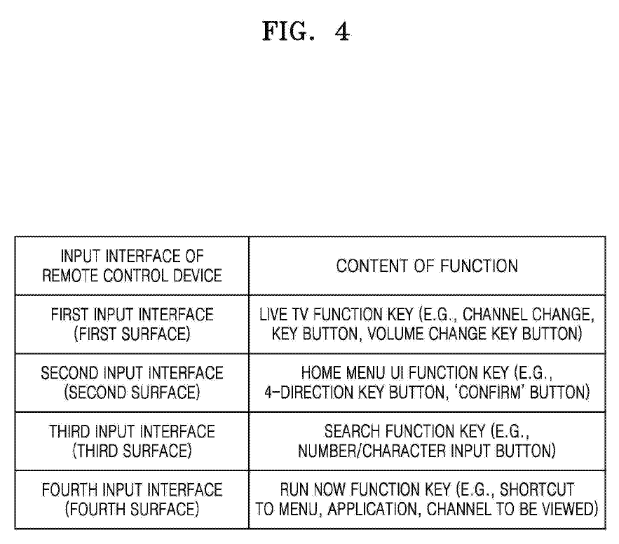

FIG. 4 is a diagram illustrating an example of a table showing information regarding functions of buttons included in the first to fourth input interfaces 311 to 314 of the remote control device 100 according to an example embodiment.

Referring to FIG. 4, a live TV function button may be provided on the first input interface 311, a home memory user interface (UI) function button may be provided on the second input interface 312, a search function button may be provided on the third input interface 313, and a run now function button (or a shortcut function button) may be provided on the fourth input interface 314.

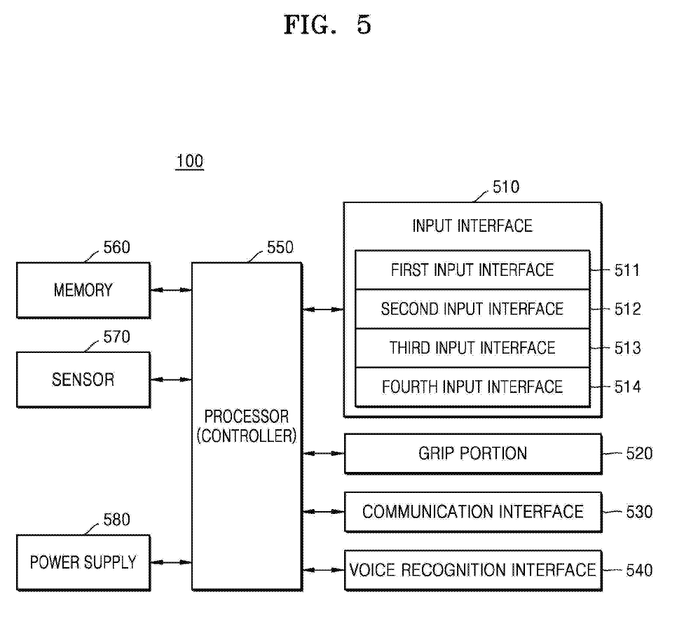

A functional block diagram of the multi-dimensional remote control device 100 according to the present disclosure is not limited to that illustrated in FIG. 3. For example, the multi-dimensional remote control device 100 according to the present disclosure may be configured as illustrated in FIG. 5.

FIG. 5 is a block diagram illustrating an example remote control device 100 according to another example embodiment.

FIG. 5 illustrates a case in which a voice recognition function is added to the remote control device 100 of FIG. 3. Referring to FIG. 5, the remote control device 100 includes a input interface (e.g., including input circuitry) 510, a grip portion 520, a communication interface (e.g., including communication circuitry) 530, a voice recognition interface (e.g., including voice recognition circuitry) 540, a processor (e.g., including processing circuitry) 550, a memory 560, a sensor 570, and a power supply 580.

The sensor 570 may include a sensor for sensing whether the remote control device 100 is in a standing state. The sensor 570 may include, but is not limited to, a contact sensor mounted on a lower side surface of the remote control device 100 to sense whether the remote control device 100 is in the standing state.

The sensor 570 may further include a sensor for sensing at least one of a direction of rotation and an angle of rotation (an azimuth) of the remote control device 100 as described above with reference to FIG. 3, and a light detection sensor (or an illumination sensor, a light sensor, or a light-emitting diode (LED) sensor). In the present disclosure, the sensor included in the sensor 570 is not limited to that described above.

Examples of the sensor 570 may include, but are not limited to, a bio-sensor (or a health sensor, e.g., a heartbeat sensor, a blood flow rate sensor, a diabetes sensor, a blood pressure sensor, and/or a stress sensor) which senses information regarding a user's health, a moodscope sensor which senses mood of a user of the remote control device 100, a motion detection sensor which senses activity, a position sensor (e.g., a global positioning system (GPS) receiver) which senses a location of the remote control device 100, an accelerometer sensor which measures the inclination of the remote control device 100 with respect a surface of the earth, acceleration, etc., and/or a terrestrial magnetism sensor which senses cardinal points north, south, east, and west with respect to the remote control device 100.

When it is determined that the remote control device 100 is in a standing state according to a sensing result output from the sensor 570, the processor 550 may activate the voice recognition interface 540. Thus, the processor 550 may receive a user's voice signal via the voice recognition interface 540. The user's voice signal may be referred to as an audio signal.

When a user's voice signal is received via the voice recognition interface 540, the processor 550 may transmit the user's voice signal to the electronic device 110 via the communication interface 530.

The communication interface 530 may include various communication circuitry and may also convert the user's voice signal into a form which may be transmitted to the electronic device 110. The user's voice signal may be converted into text information to change the user's voice signal into the form which may be transmitted to the electronic device 110. Information needed to convert the user's voice signal into the text information may be stored in the memory 560. The information needed to convert the user's voice signal into the text information may include information regarding mapping between the user's voice signal and the text information.

The input interface 510, the grip portion 520, the communication interface 530, the processor 550, and the memory 560 illustrated in FIG. 5 may be configured and operated similar to the input interface 310, the grip portion 330, the communication interface 350, the processor 320, and the memory 360 described above with reference to FIG. 3.

The power supply 580 may supply power to the remote control device 100. The power supply 580 may be configured in the form of a battery. The power supply 580 may include a power management integrated circuit (PMIC) or a charger integrated circuit (IC). The power supply 580 may be embodied as a connector which may be connected to an external power source. The power supply 580 may supply power to the remote control device 100 through wireless communication.

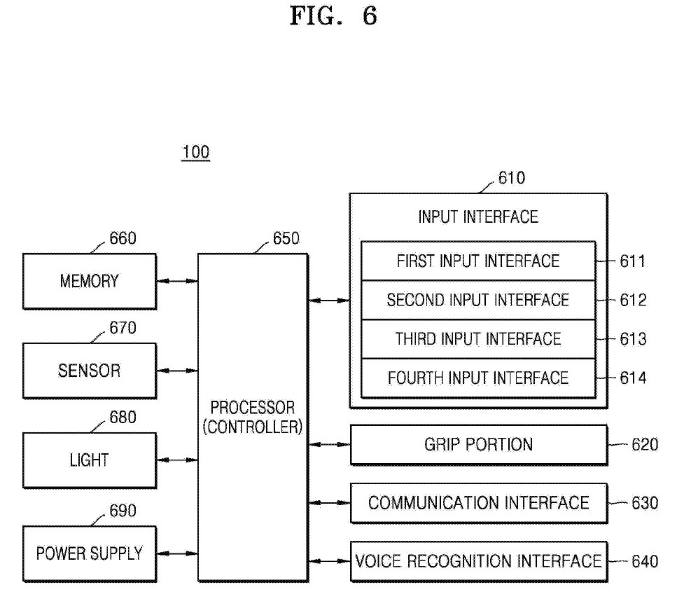

FIG. 6 is a block diagram illustrating an example remote control device 100 according to another example embodiment. The remote control device 100 of FIG. 6 further includes a function of emitting light representing an activated surface of the remote control device 100, compared to the remote control device 100 of FIG. 5.

The remote control device 100 of FIG. 6 includes an input interface (e.g., including input circuitry) 610, a grip portion 620, a communication interface (e.g., including communication circuitry) 630, a voice recognition interface (e.g., including voice recognition circuitry) 640, a memory 660, a sensor 670, a light 680, and a power supply 690.

The input interface 610, the grip portion 620, the communication interface 630, the voice recognition interface 640, the memory 660, the sensor 670, and the power supply 690 of FIG. 6 may be configured and operated similar to the input interface 510, the grip portion 520, the communication interface 530, the voice recognition interface 540, the memory 560, the sensor 570, and the power supply 580 of FIG. 5.

The light 680 may include various light emitting components and circuitry for controlling the same, and be configured to emit light informing a user of a surface on which an activated input interface is located among surfaces of the remote control device 100.

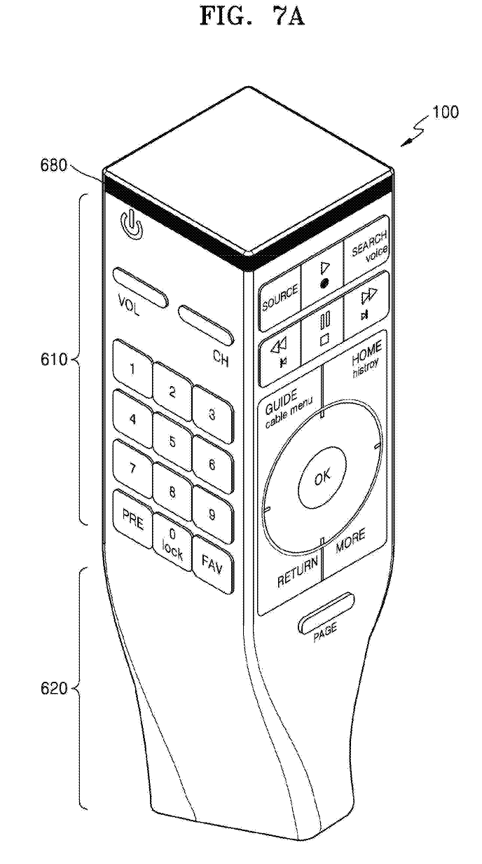

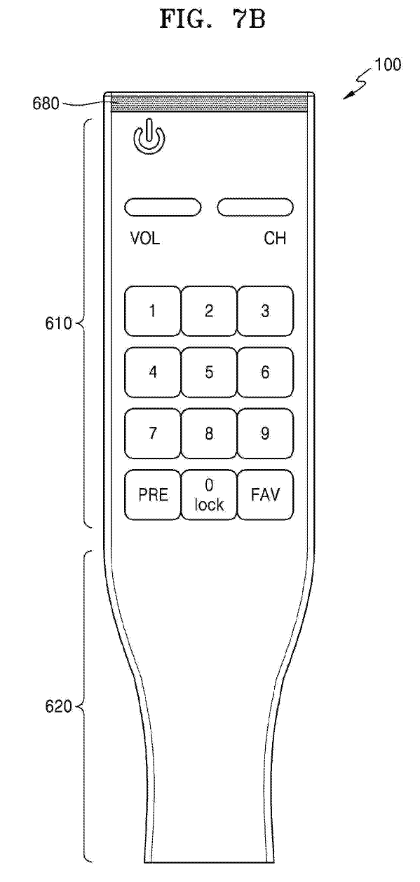

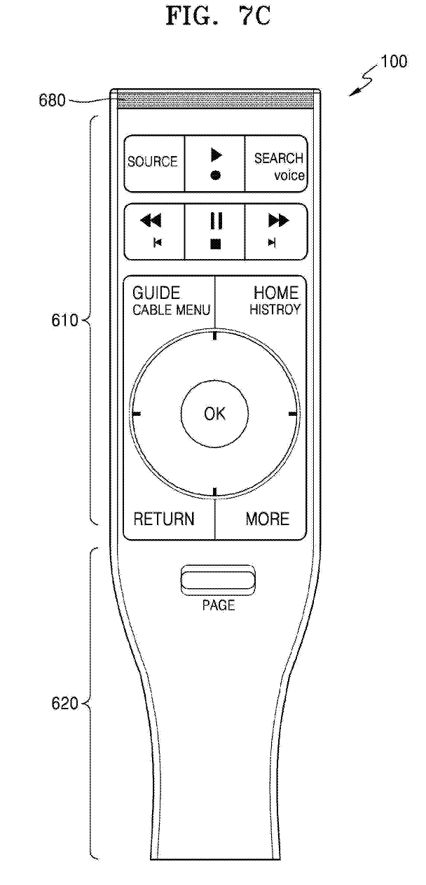

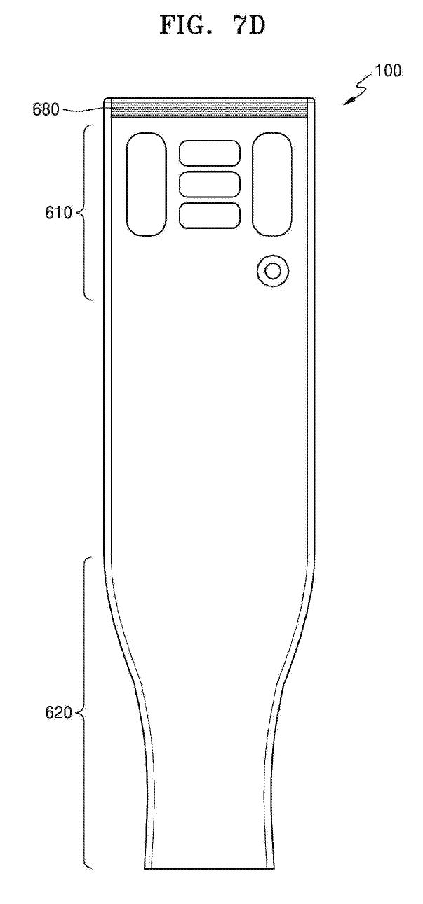

FIGS. 7A, 7B, 7C and 7D are diagrams illustrating example cases in which a remote control device 100 includes a light 680 emitting light representing an activated surface of the remote control device 100, according to example embodiments.

FIG. 7A illustrates a case in which light is not emitted from the light 680. FIG. 7B illustrates a case in which as a front surface of the remote control device 100 is activated, light is emitted from a region of the light 680 corresponding to the front surface to represent an activated state of the front surface. FIG. 7C illustrates a case in which as a right side surface of the remote control device 100 is activated, light is emitted from a region of the light 680 corresponding to the right side surface to represent an activated state of the right side surface.

FIG. 7D illustrates a case in which as a left side surface of the remote control device 100 is activated, light is emitted from a region of the light 680 corresponding to the left side surface to represent an activated state of the left side surface.

The light 680 may be configured such that light is emitted from a region thereof corresponding to an activated surface of the remote control device 100 but may include a plurality of lights corresponding to surfaces of the remote control device 100. When the light 680 includes a plurality of lights corresponding to the surfaces of the remote control device 100, the remote control device 100 may include circuitry that controls a turn on or off of the light corresponding to a surface thereof corresponding to an activated input interface. The light 680 may be located at lower layers of input interfaces 611 to 614. When the light 680 is located at the lower layers of the input interfaces 611 to 614, light may be emitted from the light at the lower layer of an activated input interface among the input interfaces 611 to 614.

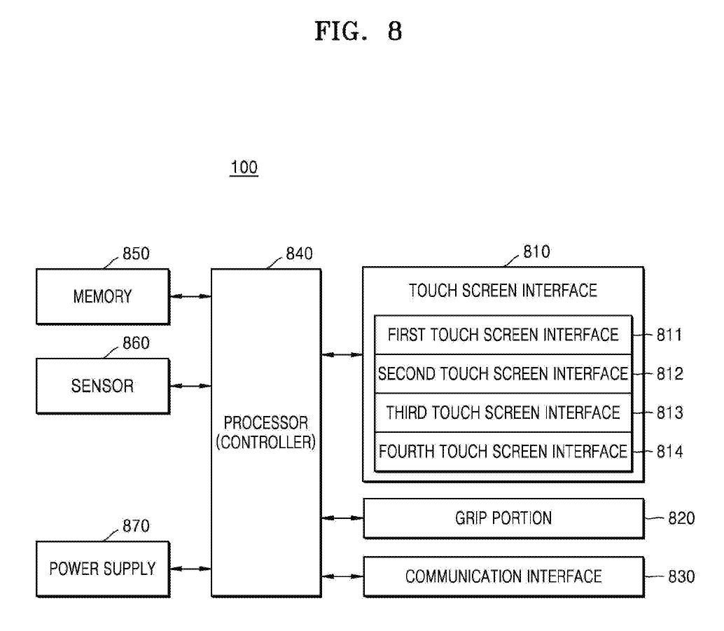

FIG. 8 is a block diagram illustrating an example remote control device 100 according to another example embodiment. The remote control device 100 of FIG. 8 includes a touch screen 810.

Referring to FIG. 8, the remote control device 100 includes a touch screen 810, a grip portion 820, a communication interface (e.g., including communication circuitry) 830, a processor (e.g., including processing circuitry) 840, a memory 850, a sensor 860, and a power supply 870.

The touch screen 810 includes first to fourth touch screens 811 to 814. The first to fourth touch screens 811 to 814 may be of a resistive type, an electrostatic type, an optical type, or an ultrasound type but are not limited thereto.

The grip portion 820, the communication interface 830, the memory 850, the sensor 860, and the power supply 870 of FIG. 8 may be configured and operated similar to the grip portion 620, the communication interface 630, the sensor 670, and the power supply 690 described above with reference to FIG. 6.

The processor 840 may set a screen save mode and an input reception blocking mode when the first to fourth touch screens 811 to 814 are in an inactive state and may cancel the screen save mode and set an input reception mode when the first to fourth touch screens 811 to 814 are in an active state.

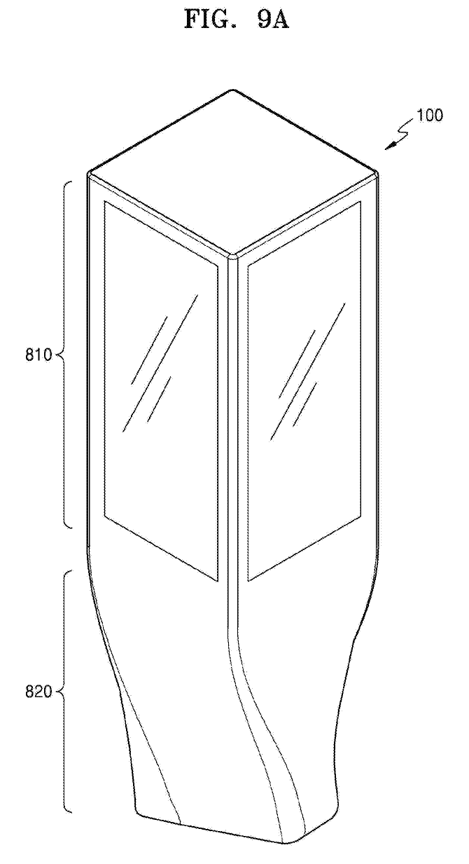

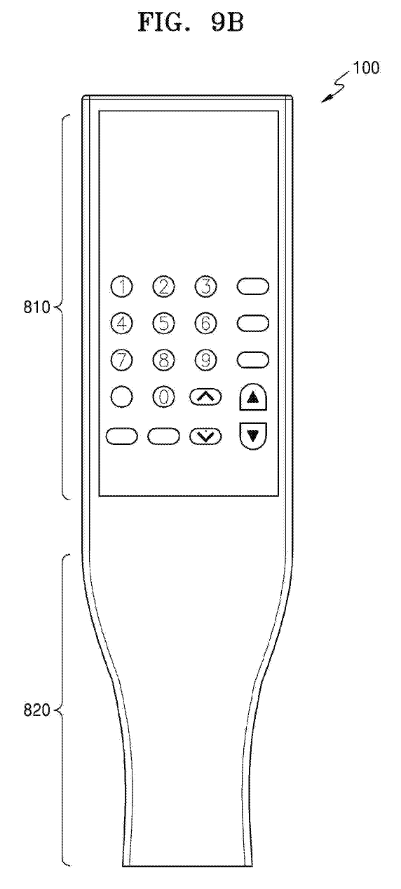

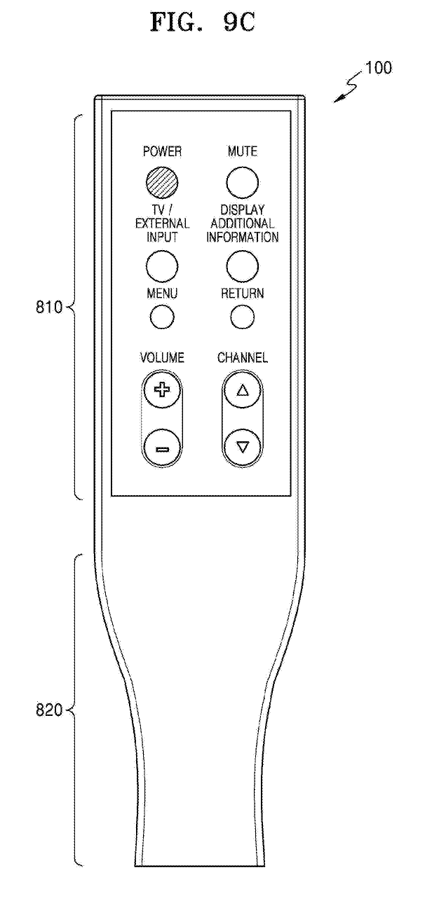

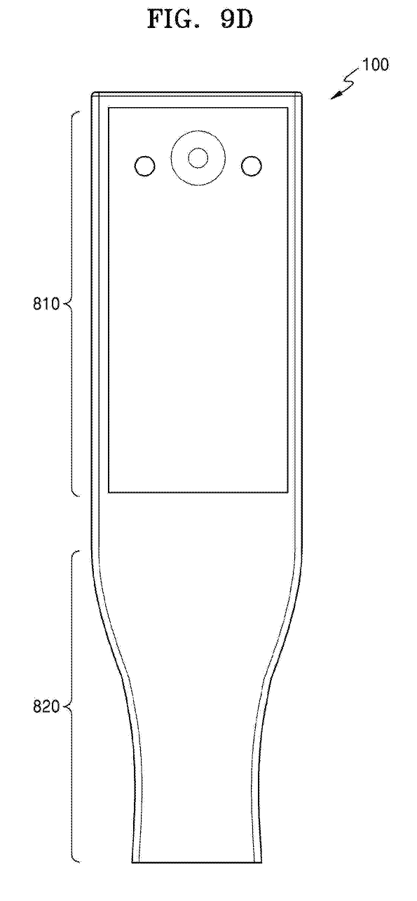

FIGS. 9A, 9B, 9C and 9D are diagrams illustrating examples of an appearance of a remote control device 100 according to embodiments, in which input interfaces include touch screens.

FIG. 9A illustrates the appearance of the remote control device 100 corresponding to that of the remote control device 100 of FIG. 2A, in which both touch screens are in a screen save mode. FIG. 9B illustrates a case in which a touch screen on a front surface of the remote control device 100 is activated. FIG. 9C illustrates a case in which a touch screen on a right side surface of the remote control device 100 is activated. FIG. 9D illustrates a case in which a touch screen on a left side surface of the remote control device 100 is activated.

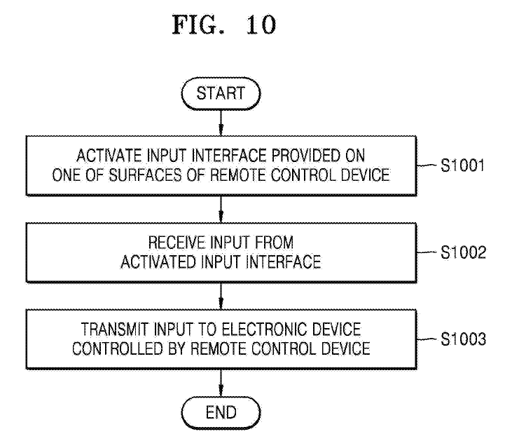

FIG. 10 is a flowchart illustrating an example method of controlling an operation of the remote control device 100 according to an example embodiment. This method may be realized using a computer program. For example, this method may be performed using an application installed in the remote control device 100. The computer program described above may be executed in an environment of an operating system (OS) installed in the remote control device 100. The remote control device 100 may write the computer program to a storage medium and use the computer program by reading it from the storage medium.

In operation S1001, the remote control device 100 activates an input interface provided on one of multiple surfaces thereof. The activation of the input interface provided on at least one of the multiple surfaces of the remote control device 100 may be determined based on at least one of a direction of rotation and an angle of rotation of the remote control device 100 as described above with reference to FIG. 3 or 5 but is not limited thereto in the present disclosure. For example, the activation of the input interface may be determined according to a sensing value output from a light detection sensor mounted on the grip portion 201 of the remote control device 100.

In operation S1002, the remote control device 100 receives an input from the activated input interface. In operation S1003, the remote control device 100 transmits the input to the electronic device 110 controlled by the remote control device 100. In order to transmit the input to the electronic device 110, the remote control device 100 may convert the input into a data form to be communicated between the remote control device 100 and the electronic device 110.

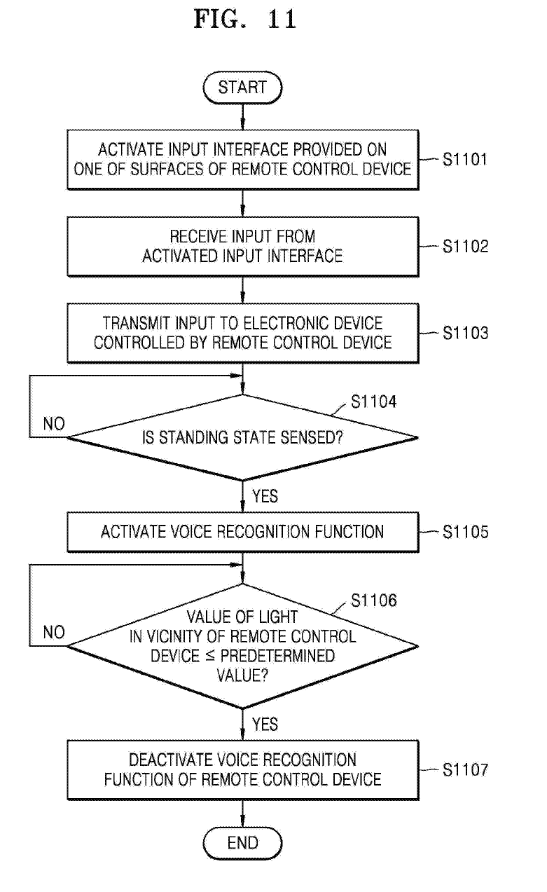

FIG. 11 is a flowchart illustrating an example method of controlling an operation of the remote control device 100 according to another example embodiment. This method may be realized using a computer program. For example, this method may be performed using an application installed in the remote control device 100. The computer program described above may be operated in an environment of an OS installed in the remote control device 100. The remote control device 100 may write this computer program to a storage medium and use the computer program by reading it from the storage medium.

Operations S1101 to S1103 are substantially the same as operations S1001 to S1003 of FIG. 10 and are thus not described here again to avoid redundancy.

In operation S1104, the remote control device 100 determines whether it is sensed to be in a standing state. The determination of whether the remote control device 100 is in the standing state or not may be performed as described above with respect to the sensor 670 of FIG. 6.

In operation S1105, when it is determined that the remote control device 100 is sensed to be in the standing state, the remote control device 100 activates a voice recognition function thereof. Thus, the remote control device 100 may receive a user's voice signal. When the user's voice signal is received, the remote control device 100 may transmit it to the electronic device 110. The remote control device 100 may convert the user's voice signal into text information and transmit the text information to the electronic device 110 as described above with reference to FIG. 6.

In operation S1106, the remote control device 100 determines whether light in the vicinity of the remote control device 100 has a value equal to or less than a predetermined value. In operation S1106, when it is determined that the light in the vicinity of the remote control device 100 has a value equal to or less than the predetermined value, the remote control device 100 deactivates the voice recognition function thereof in operation S1107. Thus, the remote control device 100 cannot receive the user's voice signal.

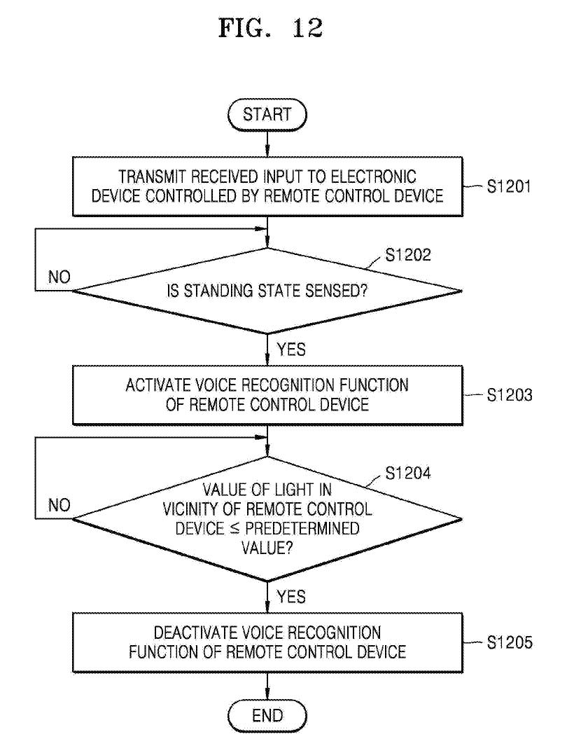

FIG. 12 is a flowchart illustrating an example method of controlling an operation of the remote control device 100 according to another example embodiment. This method may be realized using a computer program. For example, this method may be performed using an application installed in the remote control device 100. The computer program described above may be operated in an environment of an OS installed in the remote control device 100. The remote control device 100 may write this computer program to a storage medium and use the computer program by reading it from the storage medium.

In operation S1201, a received input is transmitted to the electronic device 110 controlled by the remote control device 100.

In operation S1202, the remote control device 100 senses whether it is in the standing state. In operation S1202, when it is sensed that the remote control device 100 is in the standing state, the remote control device 100 activates a voice recognition function thereof in operation S1203. Thus, the remote control device 100 may receive a user's voice signal and transmit it to the electronic device 110 as described above with respect to operation S1106 of FIG. 11. The remote control device 100 may convert the user's voice signal into text information and transmit the text information to the electronic device 110. A form of the text information transmitted to the electronic device 110 may vary according to a communication method established between the remote control device 100 and the electronic device 110.

Operations S1204 and S1205 may be substantially the same as operations S1106 and S1107 described above.

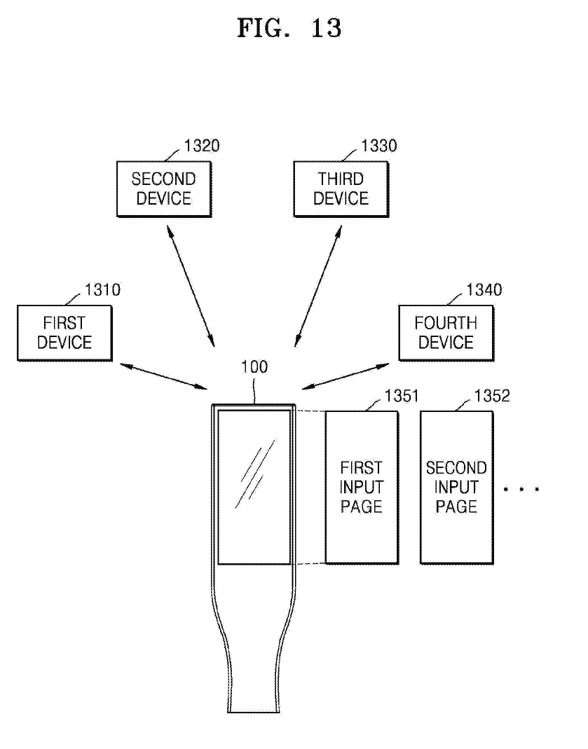

FIG. 13 is a diagram illustrating an example of controlling a plurality of devices using a remote control device 100 according to an example embodiment. The plurality of devices may be electronic devices having different functions but may be electronic devices having similar functions.

Referring to FIG. 13, an input interface of a device to be controlled for each of surfaces of the remote control device 100 may be registered based on communication established among first to fourth devices 1310 to 1340 and the remote control device 100.

For example, the remote control device 100 may register a first input interface (or a first surface) as an input interface of the first device 1310, a second input interface (or a second surface) as an input interface of the second device 1320, a third input interface (or a third surface) as an input interface of the third device 1330, and a fourth input interface (or a fourth surface) as an input interface of the fourth device 1340.

The input interfaces on the surfaces of remote control device 100 of FIG. 13 may be embodied as touch screens as illustrated in FIG. 8. Thus, when a registered device has a large number of functions, a plurality of input pages (e.g., a first input page 1351 and a second input page 1352) may be provided on one surface of the remote control device 100. As the input interfaces are embodied as touch screens as described above, the remote control device 100 may provide a next input page or a previous input page according to a touch input such as a long touch or a touch-and-drag input.

When a plurality of input pages are provided on one surface of the remote control device 100, the remote control device 100 may output a notice message informing of this fact. The remote control device 100 of FIG. 13 may activate an input interface provided on one of the surfaces thereof on the basis of at least one of a direction of rotation and an angle of rotation of the remote control device 100 as described above with reference to FIG. 3, 5, 6, or 8. When the input interface on one of the surfaces is activated, the remote control device 100 may control a device registered with the activated input interface.

An embodiment of the present disclosure may be embodied as a computer-readable recording medium having recorded thereon computer-executable commands such as a program module executed by a computer. The computer-readable recording medium may be any medium accessible by a computer, and include a volatile/nonvolatile medium and a separable/non-separable medium. Furthermore, the computer-readable recording medium may include a computer storage medium and a communication medium. The computer-readable recording medium may include a volatile/nonvolatile medium and a separable/non-separable medium realized according to any method or technology to store information such as computer-readable commands, data structures, program modules, or other data. In general, the communication medium includes a computer-readable command, a data structure, a program module, data of a modulated data signal, or a transmission mechanism, and may include any information transfer medium.

The present disclosure described above merely provides examples and it will be understood by those of ordinary skill in the art that the present disclosure may be embodied in many different forms without departing from the spirit and scope of the present disclosure. Thus, the various example embodiments set forth herein should be considered in descriptive sense only and not for purposes of limitation. For example, elements described as being included in a single unit may be dispersed and elements described as being dispersed may be combined with one another.

Therefore, the scope of the present disclosure is defined not by the detailed description but by the appended claims, and all differences within the scope will be understood as being included in the present disclosure.

What is claimed is:

1. A remote control device configured to control an electronic device, the remote control device comprising:
an input interface provided on at least one of multiple surfaces of the remote control device, and configured to receive an input;
a grip portion;
a communication interface comprising communication circuitry configured to establish communication with the electronic device; and
a processor configured to activate an input interface provided on one of the multiple surfaces, to receive an input from the activated input interface, and to transmit the received input to the electronic device via the communication interface.

2. The remote control device of claim 1, further comprising a sensor configured to detect at least one of: a direction of rotation of the remote control device, and an angle of rotation of the remote control device, and
wherein the processor is further configured to detect a surface facing upward from among the multiple surfaces based on a sensing value output from the sensor, and to activate an input interface provided on the detected surface.

3. The remote control device of claim 1, further comprising a light detection sensor installed on the grip portion and configured to sense light in a vicinity of the grip portion, and
wherein the processor is further configured to activate the input interface provided on the one of the multiple surfaces based on a sensing value output from the light detection sensor.

4. The remote control device of claim 1, further comprising:
a sensor configured to sense whether the remote control device is in a standing state; and
a voice recognition interface comprising voice recognition circuitry configured to recognize a voice signal,
wherein, when it is determined, based on a sensing value output from the sensor, that the remote control device is in the standing state, the processor is further configured to activate the voice recognition interface, to receive a voice signal via the voice recognition interface, and to transmit the voice signal to the electronic device via the communication interface.

5. The remote control device of claim 4, further comprising a light detection sensor installed in the grip portion and configured to sense light in a vicinity of the remote control device, and
wherein after the voice recognition interface is activated, the processor is further configured to deactivate the voice recognition interface when it is determined, based on a sensing value output from the light detection sensor, that the light in a vicinity of the remote control device is equal to or greater than a predetermined value.

6. The remote control device of claim 4, further comprising a light emitting element configured to emit light to the outside of the remote control device, and
wherein, when the voice recognition interface is activated, the processor is further configured to control the light emitting element to emit light indicating an activated state of the voice recognition interface.

7. The remote control device of claim 1, further comprising a light emitting element mounted on some regions of the multiple surfaces,
wherein the processor is further configured to control the light emitting element to emit light indicating a surface corresponding to the activated input interface.

8. The remote control device of claim 1, wherein the input interface comprises a touch screen, and
the processor is further configured to cancel a screen save mode and set an input reception mode for a touch screen mounted on an activated surface of the multiple surfaces, and to set the screen save mode and an input reception blocking mode for a touch screen mounted on a deactivated surface of the multiple surfaces.

9. A method of controlling an operation of a remote control device for controlling an electronic device, the method comprising:
activating an input interface provided on one of multiple surfaces of the remote control device;
receiving an input from the activated input interface; and
transmitting the input to the electronic device.

10. The method of claim 9, wherein the activating of the input interface provided on one of the multiple surfaces of the remote control device comprises:
detecting at least one of a direction of rotation of the remote control device, and an angle of rotation of the remote control device;
detecting a surface facing upward from among the multiple surfaces based on the detected at least one of the direction of rotation and the angle of rotation; and
activating the input interface provided on the detected surface.

11. The method of claim 9, wherein the activating of the input interface provided on one of the multiple surfaces of the remote control device comprises:
sensing light in the vicinity of a grip portion of the remote control device; and
activating an input interface provided on one of the multiple surfaces based on a value of the sensed light.

12. The method of claim 9, further comprising:
determining whether the remote control device is in a standing state; and
activating a voice recognition function of the remote control device when it is determined that the remote control device is in the standing state.

13. The method of claim 12, further comprising:
sensing light in a vicinity of the remote control device after the voice recognition function of the remote control device is activated; and
deactivating the voice recognition function when it is determined that the light in the vicinity of the remote control device has a value equal to or less than a predetermined value.

14. The method of claim 13, further comprising emitting light indicating an activated state of the voice recognition function to outside of the remote control device when the voice recognition function is activated.

15. The method of claim 9, when the input interface provided on the surface of the multiple surfaces is activated, further comprising emitting light indicating the surface corresponding to the activated input interface to outside of the remote control device.

16. The method of claim 9, wherein, when input interfaces provided on the multiple surfaces are touch screens, the activating of the input interface provided on the surface from among the multiple surfaces comprises:
canceling a screen save mode and setting an input reception mode for a touch screen mounted on the activated surface from among the multiple surfaces; and
setting the screen save mode and an input reception blocking mode for a touch screen mounted on a deactivated surface from among the multiple surfaces.

17. A non-transitory computer readable storage medium having stored thereon program instructions, which when executed by a processor, cause a remote control device to perform operations comprising:
activating an input interface provided on one of multiple surfaces of the remote control device;
receiving an input from the activated input interface; and
transmitting the input to the electronic device.
